(19) United States
(12) Patent Application Publication
(10) Pub. No.: US 2007/0257883 A1
(43) Pub. Date: Nov. 8, 2007

(54) Cursor control system and method thereof

(75) Inventor: Cheng-chang Ke, Shijr City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/418,977

(22) Filed: May 5, 2006

(51) Int. Cl. G09G 5/08

(52) U.S. Cl. 345/157

(57) ABSTRACT

A cursor control system and method thereof is disclosed. The cursor control system includes a plurality of resolution detectors, a processor and a switch. The resolution detectors analyze resolutions of video signals from the computers, respectively. The processor in response to the resolution detectors calculates movement of the pointing device for obtaining a real-time position information of an active cursor on one of the displays to generate a selecting signal indicating one of the computers. The switch switches to output signals of the keyboard and the pointing device to the indicated computer to show the active cursor on the corresponding display simultaneously to control the active cursor move from one display to another display adjacent to the aforesaid display and switching to output the signal of the pointing device from one computer coupled to the display to another computer coupled to the adjacent display automatically according to the selecting signal.

### FIELD OF THE INVENTION

The present invention generally relates to a cursor control system for controlling a plurality of computers, and more particularly to a cursor control system for controlling the active cursor move from one display to another display adjacent to the aforesaid display and switching to output signals of a keyboard or a pointing device from one computer coupled to the display to another computer coupled to the adjacent display automatically and method thereof.

### BACKGROUND OF THE INVENTION

In a network system having a plurality of video sources from computers or cameras, a user can monitor where the cameras shoot by a display at a console. The user may also control the computers and watch the display receiving the video signals from the computers at the console. According to prior arts, the user can select several video sources to be shown in small-sectorized areas in one display, such as a security monitor showing a plurality of video sources from the cameras watching different places in respective small-sectorized areas in a display, or a keyboard-video-mouse (KVM) switch system showing a plurality of desk-tops of computers in respective small-sectorized areas in a display. The user can watch the status of the computers at the same time. However, it has many drawbacks, such as one small-sectorized area showing the desk-top of one computer is too small for disclosing enough information and distinct picture for the user. Meanwhile, such technique of showing desk-tops in respective small-sectorized areas in a display only can provide watching function for the user, i.e. the user only can watch the desk-tops of the computers in a display but cannot control these computers directly on the display by a keyboard and a mouse. The user has to select one sectorized area and switch the desk-top of the sectorized area to a full screen view to remote control the computer.

Besides, for disclosing enough information and distinct pictures of plural video source, such as a TV wall showing all stock quotes for buyers in a stock exchange corporation, lots of displays occupy large space.

In a traditional keyboard-video-mouse (KVM) switch system, a user who operates a console can remote control a plurality of computers through a keyboard-video-mouse switch coupled with. The console includes a set of a keyboard, a display and a mouse for remote controlling one of the computers and showing the user's operation status on the display. When the user is going to control another of the computers, generally, an on-screen display (OSD) menu in a text mode is employed to overlap on the desk-top of the display to show all the names of the computers coupled to the KVM switch to the user. The user activates the OSD menu and selects the name of the computer desired to control listed in the OSD menu, and then the video signal of the selected computer will be received by the KVM switch and transmitted to the display of the console, which the user is operating. The desk-top of the selected computer will be shown on the display. Meanwhile, the remote control access of the console will also be switched to link to the selected computer by the KVM switch. At this time, the user's operation status to another computer selected in the OSD menu will be shown on the display of the console.

However, with the increased number of the computers coupled to the KVM switch system, the management loading for the whole system is increased and getting more complicated. Such as the user is proceeding an installation of a software program updating for one of the plurality of computers and controlling another of the plurality of computers to execute some job and collecting and saving data therefor, the user has to watch the operation status of both computers at the same time. Therefore, showing the operation status of the two computers for user becomes necessary. According to the traditional KVM switch, the user has to activate the OSD menu and selects to switch the operation status to show on the display and the remote control access of the console between two computers alternately. This does cause the user a quite inconvenient work, not to mention once the number of the computers, which are necessary to watch for, is increased. Even a Matrix KVM switch, which is late presented to the public provides multiple remote control accesses to a plurality of computers, it still has some restriction on giving the user powerful control ability as desired.

The matrix KVM switch can couple a plurality of computers to plural sets of consoles to provide the respective operation statuses to show on the respective displays and the remote control accesses of the respective consoles to the respective computers, simultaneously. However, the matrix KVM switch is basically developed for the purpose of multi-user operation for plural users at different places. Therefore, the plural sets of consoles must be prepared for the users. Even the plural sets of consoles set up for a single user at one place. Such as a plurality of displays in a rack but the keyboards and the pointing devices (mouse) with same number of the displays are prepared for one single user, the sets of consoles still cannot be a good resolution for one single user to control a plurality of computers simultaneously. The user has to use the different keyboards and the pointing devices (mouse) to control the different computers. Consequentially, there is a need to develop a cursor control system for a plurality of displays to control an active cursor of one pointing device move from one display to another display adjacent to the aforesaid display and switching to output the signal of the keyboard or the pointing device to the different computers automatically.

### SUMMARY OF THE INVENTION

To solve the foregoing drawbacks in the prior art, it is an objective of the present invention is to provide a cursor control system to control the active cursor move from the display to the adjacent corresponding position of the adjacent display without manual switching to output a signal of a keyboard or a pointing device to any of the computers.

To solve the foregoing drawbacks in the prior arts, it is an objective of the present invention is to provide a cursor control system for displays and method thereof. The cursor control system includes a plurality of resolution detectors, a processor and a switch. The resolution detectors analyze resolutions of video signals from the computers, respectively. The processor in response to the resolution detectors calculates movement of the pointing device for obtaining a real-time position information of an active cursor on one of the displays to generate a selecting signal indicating one of the computers. The switch switches to output signals of the keyboard or the pointing device to the indicated computer to show the active cursor on the corresponding display simultaneously according to the selecting signal. A user can control the active cursor move from the display to the adjacent corresponding position of the adjacent display without manual switch operation.

The active cursor is the cursor showed on the corresponding display coupled to the indicated computer according to the real-time position information obtained by the calculation of the processor. The cursor control system according to the present invention further includes a matrix switch, which is coupled to the computers, the displays and the resolution detectors for selecting the computers of equal number to the resolution detectors for transmitting the video signals from each of the selected computers to each of the displays, respectively. The processor calculates the movement of the pointing device based on an algorithm, which is predetermined according to an arrangement of the displays. The arrangement of the displays can in a line or a rectangularity. Both will minimize the calculation of the algorithm in processor and should be better considerations about the user's intuition to recognize the relation about the displays.

The present invention also provides a cursor control method to control the active cursor move from the display to the adjacent corresponding position of the adjacent display and switching to output signals of the pointing device or the keyboard to the computers automatically. The method comprises steps of:

calculating movement of the pointing device by an algorithm to obtain a real-time position information of an active cursor on one of the displays;

generating a selecting signal indicating one of the computers according to the real-time position information;

switching to output signals of the keyboard or the pointing device to one of the indicated computer to show the active cursor on the corresponding display simultaneously according to the selecting signal; and

controlling the active cursor move from the display to the adjacent corresponding position of the adjacent display.

In the algorithm for obtaining the real-time position information, the cursor control method of the present invention further comprises steps of below:

setting an active cursor controlled by the pointing device starting on one of the displays as default;

synchronizing the position of the active cursor to move the active cursor back to the original position of the default display;

detecting the movement of the pointing device to obtain the real-time position information of the active cursor;

determining the real-time position of the active cursor on which of the displays to generate the selecting signal indicating one of the computers; and

calculating an adjacent corresponding position of the adjacent display, which the active cursor is moved to, to control the active cursor move from the default display to the adjacent corresponding position of the adjacent display according to the selecting signal.

According to the cursor control system and method thereof of the present invention, the user can control the active cursor of a pointing device move from the display to the adjacent corresponding position of the adjacent display. Furthermore, the cursor control system outputs signals of the pointing device or the keyboard to the computers automatically without a manual switch operation by the selecting signal obtained from the calculation of the real-time position information.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a block diagram of a matrix keyboard-mouse-video switch system, controlling a plurality of computers by a keyboard and a pointing device coupled to plural console modules through a keyboard-video-mouse switch.

FIG. 2 illustrates a block diagram of a matrix keyboard-mouse-video switch system, controlling a plurality of computers by a keyboard or a pointing device coupled to one of plural console modules.

FIG. 3 illustrates a functional block diagram inside the matrix KVM switch shown in FIG. 2, by which is capable of controlling the active cursor of the pointing device move from one display to another display adjacent to the aforesaid display according to a first embodiment of the present invention.

FIG. 4 illustrates a functional block diagram of a cursor control system, controlling a plurality of computers by a keyboard or a pointing device, by which is capable of controlling an active cursor of the pointing device move from one display to another display adjacent to the aforesaid display according to a second embodiment of the present invention.

FIG. 5 shows a first arrangement of the displays according to the present invention.

FIG. 6 shows a calculation flow chart of an algorithm, predetermined according to the first arrangement of the displays shown in FIG. 5 according to the present invention.

FIG. 7 shows a second arrangement of the displays according to the present invention.

FIG. 8 shows a calculation flow chart of an algorithm, predetermined according to the second arrangement of the displays shown in FIG. 7 according to the present invention.

### DETAILED DESCRIPTION OF THE PREFERRED EMBODIMENTS

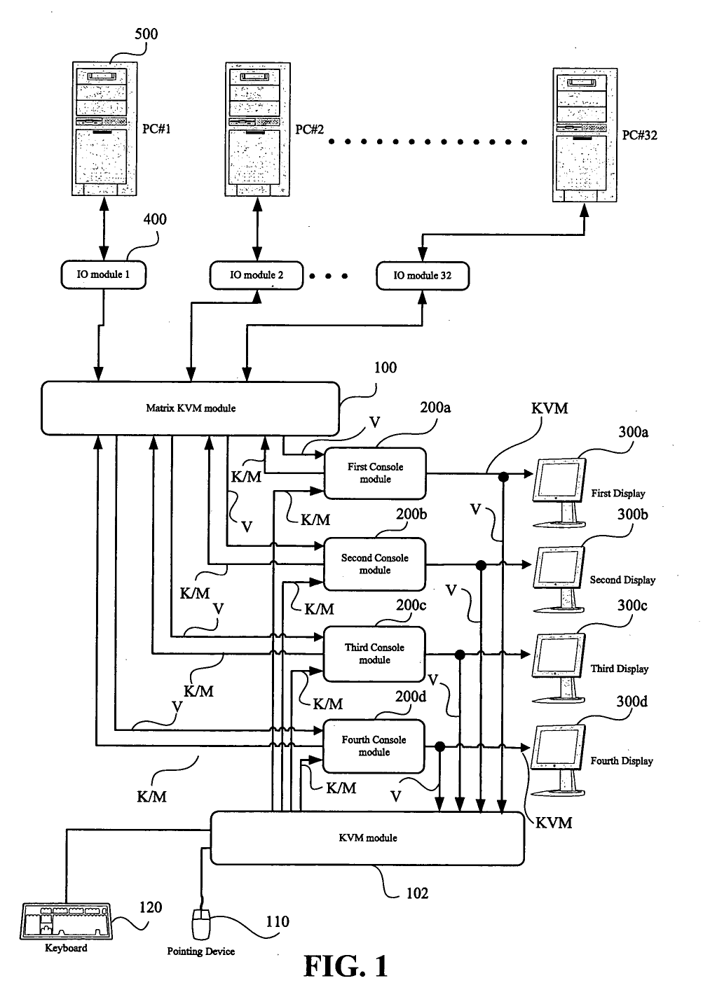

Please refer to FIG. 1, an illustration of a block diagram of a matrix keyboard-mouse-video switch system, controlling a plurality of computers by a keyboard and a pointing device coupled to plural console modules through a keyboard-video-mouse switch. The matrix KVM switch system includes a processor (not shown in FIG. 1), a matrix keyboard-mouse-video (KVM) switch 100, a pointing device 110, a keyboard 120, a plurality of console modules and a keyboard-video-mouse switch 102. In this embodiment, first console module 200a, second console module 200b, third console module 200c and fourth console module 200d are employed. Four displays, the first display 300a, second display 300b, third display 300c and fourth display 300d corresponding to the selected computers respectively are employed. Through the input/output (IO) modules (such as IO module 1 assigned 400), the video signals of the computers (such as PC#1 assigned 500) are transmitted to the aforesaid displays through the matrix KVM module 100. The arrowheads of the KM lines denote the directions of the signals of the pointing device 110 or the keyboard 120. The arrowheads of the V lines denote the directions of the video signals.

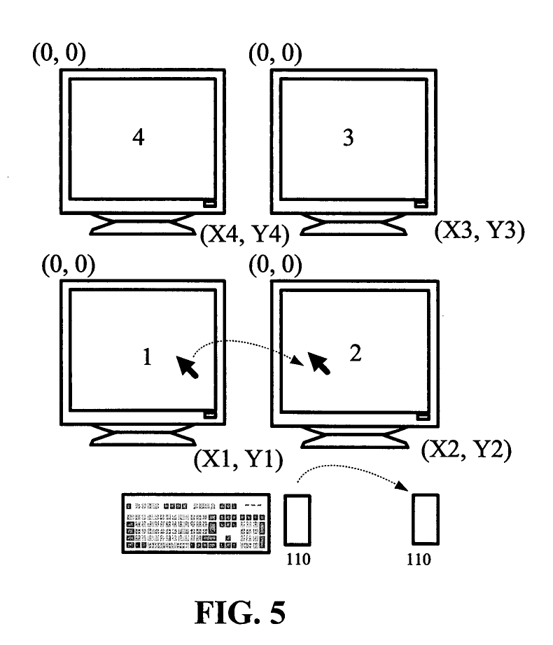

The matrix keyboard-mouse-video switch 100 is coupled to the computers PC# 1 to PC#32 for selecting four computers for transmitting the video signals from each of the selected computers through the IO modules. The first console module 200a, the second console module 200b, the third console module 200c and the fourth console module 200d are coupled to the matrix keyboard-mouse-video switch 100 respectively, to transmit the video signals from the selected computers to each of the first display 300a, the second display 300b, the third display 300c and the fourth display 300d, respectively and also transmit the signals of the keyboard 120 and the pointing device 110 to the selected computers. The processor calculates movement of the pointing device 110 for obtaining a real-time position information of an active cursor on the first display 300a, the second display 300b, the third display 300c or the fourth display 300d to generate a selecting signal indicating one of the selected computers. The KVM switch 102 switches to output the signals of the pointing device 110 or the keyboard 120 through the first console module 200a, the second console module 200b, the third console module 200c or the fourth console module 200d to show the active cursor on the corresponding display of the indicated computer simultaneously according to a selecting signal generated by the processor, which can be embedded into the KVM module 102. The processor comprises an algorithm for calculating the movement of the pointing device 110. More detail about the algorithm of the cursor control system and method thereof of the present invention will be further disclosed in the FIG. 5 to FIG. 8.

The user only needs the pointing device 110 or the keyboard 120 but being capable of controlling the selected computers, which are predetermined from the computers PC#1 to PC#32. With the cursor control system, the user can control the active cursor move from one display to another display adjacent to the aforesaid display without a manual switch operation. The active cursor can be moved on the four displays just as in one single display.

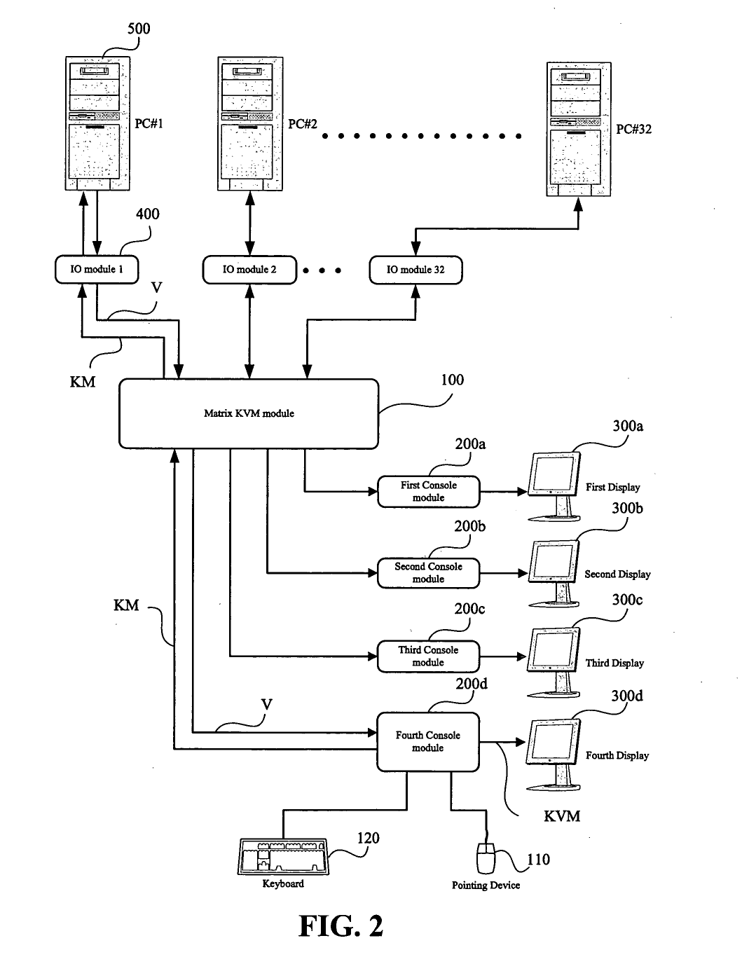

Please refer to FIG. 2, which illustrates a block diagram of a matrix keyboard-mouse-video (KVM) switch system, controlling a plurality of computers by a keyboard or a pointing device coupled to one of plural console modules. The matrix KVM switch system includes a matrix KVM module 100, a pointing device 110, a keyboard 120, and a plurality of console modules. In this embodiment, first console module 200a, second console module 200b, third console module 200c and fourth console module 200d are employed. Four displays, the first display 300a, second display 300b, third display 300c and fourth display 300d corresponding to computers, PC#1, PC#2, PC#3 and PC#4, respectively are employed. Through the input/output (IO) modules (such as IO module 1 assigned 400), the video signals of the computers (such as PC#1 assigned 500) are transmitted to the displays through the Matrix KVM module 100. Although, the number of computers 500 and the number of the coupled IO modules 400 are thirty two, it can increased depending on the capability of the matrix KVM switch 100 for coupling the computers 500 according to users' demand. In the same way, number of the console modules and the number of the displays also can increase depending on the matrix KVM switch's 100 capability and user's demand. According to the present invention, the user can use the pointing device 110 and the keyboard 120 coupled to the fourth console module 200d with the fourth display 300d to control four selected from the thirty-two computers at the same time.

What is significantly different can be told from here is that the user only needs the pointing device 110 or the keyboard 120 but being capable of controlling a plurality of computers, which are predetermined from the thirty two computers (PC#1 to PC#32) to be coupled to the corresponding displays 300a, 300b, 300c and 300d (first display, second display, third display and fourth display) simultaneously and watching the operation statuses of the four computers at the same time. Furthermore, the arrangement of the four displays 300a, 300b, 300c and 300d also should be predetermined according to the cursor control system of the present invention. With employing the cursor control system either in the Matrix KVM switch 100 or in the fourth console module, 200d of the present invention and method thereof, the user can control an active cursor of a pointing device 110. Furthermore, the cursor control system outputs the signals of the pointing device 110 or the keyboard 120 to any one of the four computers (e.g. PC#1, PC#2, PC#3 and PC#4) automatically without a manual switch. Moreover, more detail of the cursor control system and method thereof of the present invention will be further disclosed in the following FIGS.

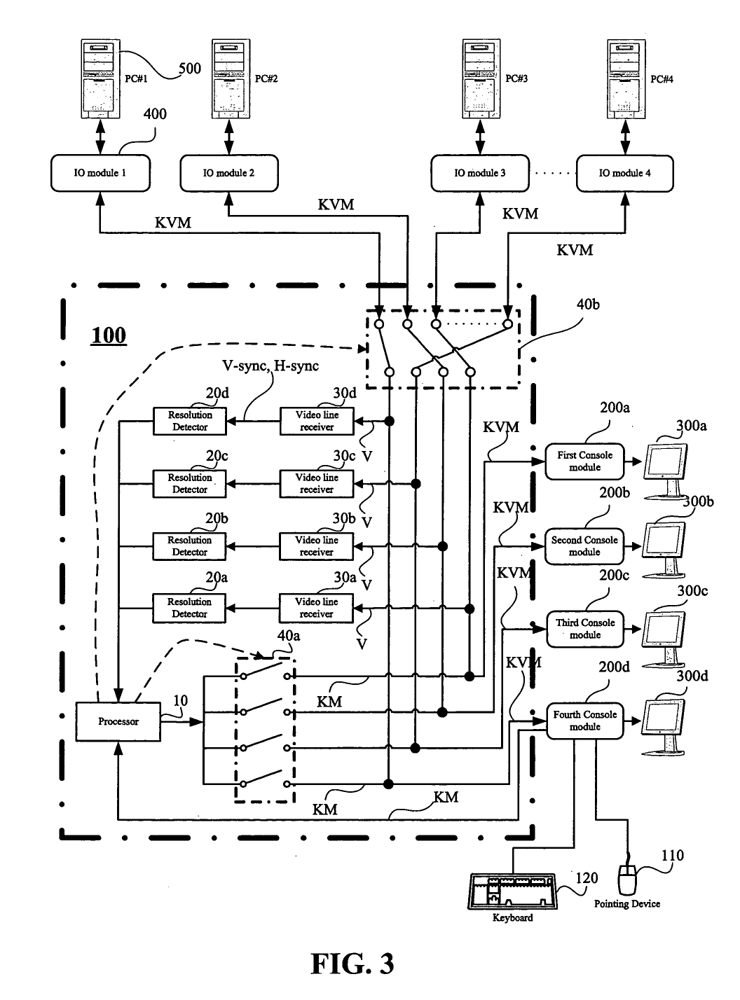

Please refer to FIG. 3, which illustrates a functional block diagram inside the matrix KVM switch 100 shown in FIG. 2, by which is capable of controlling the active cursor of the pointing device move from one display to another display adjacent to the aforesaid display according to a first embodiment of the present invention. A cursor control system is employed in the matrix KVM switch 100 in the first embodiment of the present invention. The matrix KVM switch 100 includes a matrix switch 40b, a plurality of resolution detectors (20a, 20b, 20c, 20d), a processor 10 and a switch 40a. The matrix switch 40b is coupled to the computers 500 through the IO modules 400 to select the same amount of the computers (e.g. PC#1, PC#2, PC#3 and PC#4) for transmitting the keyboard-video-mouse signals (KVM signals) from each of the computers (PC#1, PC#2, PC#3 and PC#4) to the first display 300a, second display 300b, third display 300c and fourth display 300d, respectively. The resolution detectors (20a, 20b, 20c, 20d) receive the horizontal synchronization signals and the vertical synchronization signals (V-Sync, H-sync) of the video signals to analyze the resolution of the video signals of the computers (PC#1, PC#2, PC#3 and PC#4) for the calculation of the processor 10. The IO modules 400 transform the video signals from an analog format into a differential format for the resolution detectors (20a, 20b, 20c, 20d). The matrix KVM switch 100 further includes four video line receivers (30a, 30b, 30c, 30d) receiving the video signals before the resolution detectors (20a, 20b, 20c, 20d) to equalize the video signals for the resolution detectors. Furthermore, the matrix KVM switch system further includes first console module 200a, second console module 200b, third console module 200c and fourth console module 200d, coupled to the matrix KVM switch 100 and the respective first display 300a, second display 300b, third display 300c and fourth display 300d to transform the video signals of the matrix KVM switch 100 from the differential format into the analog format for the displays (300a, 300b, 300c and 300d).

There is one respective cursor on each of the first display 300a, second display 300b, third display 300c and fourth display 300d, but there will be only one cursor being real-time controlled by the pointing device 110, which is the active cursor. The processor 10 calculates movement of the pointing device 110 for obtaining a real-time position information of the active cursor when it's shown on anyone of the first display 300a, the second display 300b, the third display 300c and the fourth display 300d. The processor 10 will generate a selecting signal indicating one of the computers (PC#1, PC#2, PC#3 and PC#4) according to the real-time position information of the active cursor. The switch 40a switches to output the signals of the keyboard 120 and the pointing device 110 to the indicated computer (e.g. PC#4 as default) to show the active cursor on the corresponding display (the fourth display) simultaneously according to the selecting signal.

Once the pointing device 110 is moved out of the frame of the fourth display to the adjacent display (e.g. the third display), the processor 10 calculates the movement and generates a selecting signal indicating to the computer (PC#3). The switch 40a will switch to output the signals of the keyboard 120 or the pointing device 110 to the computer (PC#3). The active cursor will be shown on the corresponding display (the third display) according to the selecting signal. Consequentially, the matrix KVM switch 100 can let the user to control the active cursor move from the fourth display to the third display, which is adjacent to the fourth display based on an algorithm inside the processor 10. The algorithm, which is predetermined according to an arrangement of the displays will be introduced more detail in the FIG. 5 to 8 later.

The KM (mean keyboard/mouse) lines for transmitting data shown in FIG. 3 indicate directions for transmitting the signals of the keyboard 120 and the pointing device 110. The V (video) lines for transmitting data shown in FIG. 3 indicate directions for transmitting the As standing at the processor's point, the signals of the keyboard 120 or the pointing device 110 are received from the fourth console module 200d through the switch 40a. The signals are sent to the processor 10 for calculating the movement of the pointing device 110 by the algorithm inside the processor 10 and through then the matrix switch 40b to the selected computer Because a broadcast function of the matrix KVM switch 100, the matrix KVM switch 100 can receive a signal (such as a shutdown command) from fourth console module 200d (i.e. from the keyboard 120 or the pointing device 110) with a broadcast order and then the matrix KVM switch 100 will clone and send the signal (the shutdown command) to not only the computer 500 (PC#1) but also the other computers (PC#2, PC#3, PC#4 or PC#2, PC#3 or just PC#2) according to the demand of the broadcast order. By using this broadcast function, the matrix KVM switch 100 can broadcast the signals of the keyboard 120 or the pointing device 110 from the fourth console module 200d to other console module (200a, 200b, 200c) and to other computers (PC#1, PC#2, PC#3) according to the selecting signal indicating anyone of other computers to show the active cursor on the corresponding display coupled to anyone of the other console modules. In this situation, the signals of the keyboard 120 or the pointing device 110 may also be transmitted through the fourth console module 200d, processor 10 and further through the first console module 200a, the second console module 200b, or the third console module 200c to be shown on the first display 300a, the second display 300b, or the third display 300c. Comparing to the prior art, the user only needs the pointing device 110 or the keyboard 120 but being capable of controlling four computers in this first embodiment. However, the number of four is not a restriction to the present invention but only an example. Furthermore, the broken lines started from the processor 10 to the switches 40a and the matrix switch 40b respectively represent the control signal from the processor 10 according to the calculation of the movement of the pointing device 110, the processor 10 synchronizes the switching motion of the switch 40a and the matrix switch 40bfor cooperation to transceive the keyboard-video-mouse signals between the computers, matrix KVM switch 100 and the displays.

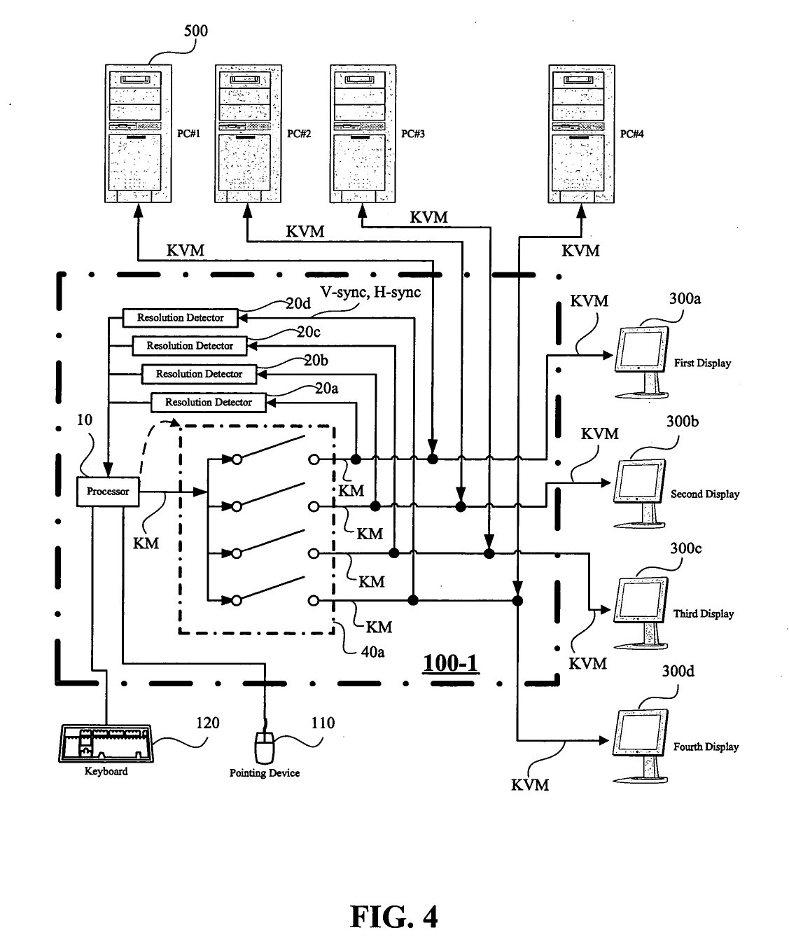

Please refer to FIG. 4, which illustrates a functional block diagram of a cursor control system 100-1, controlling a plurality of computers by a keyboard 120 or a pointing device 110, by which is capable of controlling an active cursor of the pointing device 110 move from the display to the adjacent corresponding position of the adjacent display according to a second embodiment of the present invention. The cursor control system 100-1 includes a plurality of resolution detectors (20a, 20b, 20c, 20d), a processor 10 and a switch 40a. As same description in FIG. 1 and FIG. 2, the resolution detectors (20a, 20b, 20c, 20d) analyze the resolutions of video signals from the computers (PC#1, PC#2, PC#3 and PC#4), respectively. The processor 10 in response to the resolution detectors (20a, 20b, 20c, 20d) calculates the movement of the pointing device 110 for obtaining a real-time position information of an active cursor on one of the first display 300a, the second display 300b, the third display 300c and the fourth display 300d, respectively to generate a selecting signal indicating one of the computers (PC#1, PC#2, PC#3 and PC#4). The switch 40a switches to output the signals of the keyboard 120 or the pointing device 110 to the indicated computer (one of the PC#1, PC#2, PC#3 and PC#4) to show the active cursor on the corresponding display (one of the first display 300a, the second display 300b, the third display 300c and the fourth display 300d) simultaneously according to the selecting signal to control the active cursor move from the display to the adjacent corresponding position of the adjacent display. In this second embodiment, the cursor control system can be embedded as a portion of one console module mentioned in FIG. 1 to FIG. 3 according to the present invention. Besides, being embedded as a portion of matrix KVM switch having “N” video output ports device and “M” keyboard-video-mouse signal input ports to select N computers from the M computers to arrange the N displays also can be considered for the user.

Please refer to FIG. 5. It shows a first arrangement of the displays according to the present invention. The arrangement of the physi-constructed displays can be in a rectangularity for minimizing the calculation of the algorithm. Meanwhile, such arrangement in a rectangularity is also for one better consideration about the user's intuition to recognize the relation about the first display 300a, second display 300b, third display 300c and fourth display 300d. In this first arrangement of the displays, four displays are illustrated but not a restriction to the present invention. Such as nine displays, even sixteen displays or more arranged in a rectangularity also can be considered. According to the first arrangement, the algorithm in the processor 10 shown in FIG. 3 and FIG. 4 will establish four coordinate axes (X1, Y1) for the first display 300a, (X2, Y2) for the second display 300b, (X3, Y3) for the third display 300c, and (X4, Y4) for the fourth display 300d. Each origin of each coordinate axis is set at the upper left corner of each display. The (Xn, Yn) at the lower right corner of each display denotes the resolution of the nth computer. The trajectory of the black cursor as shown in FIG. 5 denotes that the cursor can be moved from the first display 300a to the second display 300b adjacent to the first display 300a seamlessly corresponding to the movement of the pointing device 110.

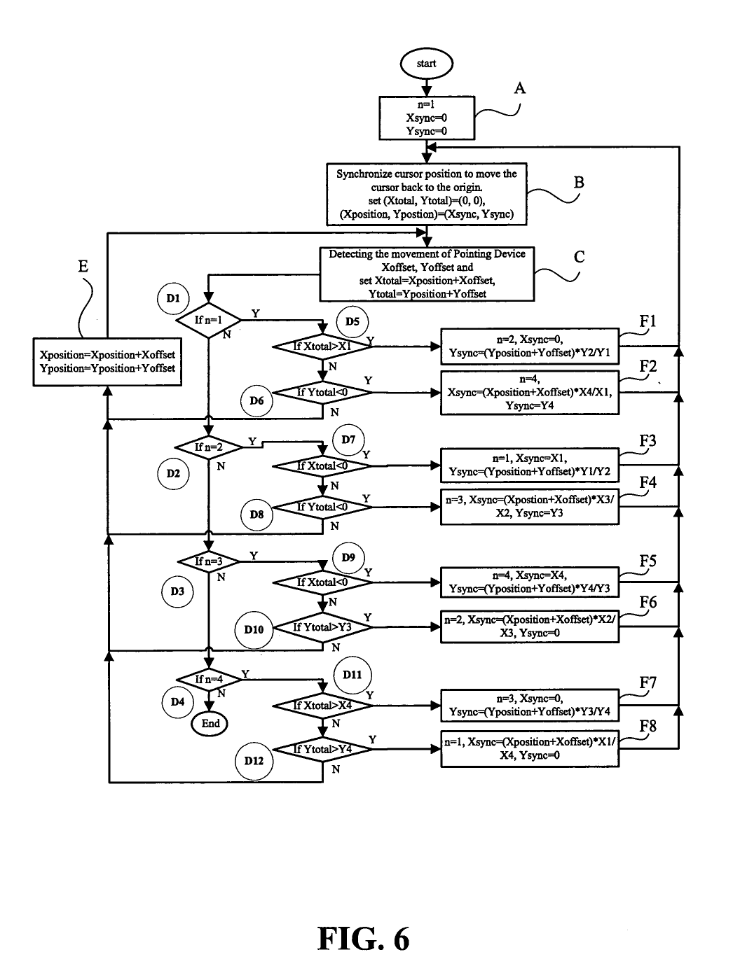

Please refer to FIG. 6, which shows a calculation flow chart of an algorithm, predetermined according to the first arrangement of the displays shown in FIG. 5 according to the present invention. First, Xsync and Ysync denote starting values of setting an active cursor position shown on the default display or the starting value calculated when the active cursor is moved from one display to another. In this first arrangement, in step A, setting the first display 300a (n=1) as the default display and the default setting is that Xsync=0 and Ysync=0, i.e. setting an active cursor controlled by the pointing device 110 starting on the first display 300a as default. In step B, the algorithm synchronizes the position of the active cursor to move the cursor back to the origin in the coordinate axis (X1, Y1). Therefore, it sets (Xtotal, Ytotal)=(0, 0) and (Xposition, Ypostion)=(Xsync, Ysync). The (Xtotal, Ytotal) denotes the total amount of the movement of the pointing device 110 in the coordinate axis (X1, Y1). (Xsync, Ysync) denotes the real position when the cursor is moved from one display to another display adjacent to the display. In step C, the processor 10 detects the movement (Xoffset, Yoffset) of pointing device 110. The algorithm inside the processor 10 calculates the movement result Xtotal=Xposition+Xoffset, Ytotal=Yposition+Yoffset, i.e. detecting the movement of the pointing device 110 to obtain the real-time position information of the active cursor on the first display 300a.

In step Dx, there will be ten judgment steps from D1 to D12. At D1 to D4 judgment steps, the algorithm will determine the real-time position of the active cursor on which of the displays. The processor 10 generates the selecting signal remains indicating the same computer. As the result in the judgment step (one of D1 to D4) is positive (Y), the algorithm will proceed the next D5 to D12.

In judgment step D1, if n=1, the algorithm will proceed to the judgment step D5 to determine if Xtotal>X1, the algorithm will proceed to the step F1, which is setting n=2, Xsync=0 and calculating Ysync=(Yposition+Yoffset)*Y2/Y1 to obtain the adjacent position information on the second display 300b to move the active cursor seamlessly from the first display 300a to the adjacent position on the second display 300b. Meanwhile the processor 10 will generate the selecting indicating the computer PC#2 to switch outputting the signal of the keyboard 120 and the pointing device 110 to the computers PC#2 automatically without user's manual operation. If the result of the judgment step D5 is negative, the algorithm will proceed to judgment step D6 to determine if Ytotal<0, the algorithm will proceed to the step F2, which is setting n=4, Ysync=Y4 and calculating Xsync=(Xposition+Xoffset)*X4/X1 to obtain the adjacent position information on the fourth display 300d to move the active cursor seamlessly from first display 300a to the adjacent position on the fourth display 300d. Meanwhile the processor 10 will generate the selecting indicating the computer PC#4 to switch outputting the signal of the keyboard 120 and the pointing device 110 to the computer PC#4 automatically without user's manual operation. If the result of the judgment step D6 is negative (N), the algorithm proceeds the step E to remain the selecting signal indicating the computer PC#1 to show the active cursor on the first display 300a.

In judgment step D2, if n=2, the algorithm will proceed to the judgment step D7 to determine if Xtotal<0, the algorithm will proceed to the step F3, which is setting n=1, Xsync=X1 and calculating Ysync=(Yposition+Yoffset)*Y1/Y2 to obtain the adjacent position information on the first display 300a to move the active cursor seamlessly from the second display 300b to the adjacent position on the first display 300a. Meanwhile the processor 10 will generate the selecting indicating the computer PC#1 to switch outputting the signal of the keyboard 120 and the pointing device 110 to the computers PC#1 automatically without user's manual operation. If the result of the judgment step D7 is negative, the algorithm will proceed to judgment step D8 to determine if Ytotal<0, the algorithm will proceed to the step F4, which is setting n=3, Ysync=Y3 and calculating Xsync=(Xpostion+Xoffset)*X3/X2 to obtain the adjacent position information on the third display 300c to move the active cursor seamlessly from the second display 300b to the adjacent position on the third display 300c. Meanwhile the processor 10 will generate the selecting indicating the computer PC#3 to switch outputting the signal of the keyboard 120 and the pointing device 110 to the computer PC#3 automatically without user's manual operation. If the result of the judgment step D8 is negative (N), the algorithm proceeds the step E to remain the selecting signal indicating the computer PC#2 to show the active cursor on the second display 300b.

In judgment step D3, if n=3, the algorithm will proceed to the judgment step D9 to determine if Xtotal<0, the algorithm will proceed to the step F5, which is setting n=4, Xsync=X4 and calculating Ysync=(Yposition+Yoffset)*Y4/Y3 to obtain the adjacent position information on the fourth display 300d to move the active cursor seamlessly from the third display 300c to the adjacent position on the fourth display 300d. Meanwhile the processor 10 will generate the selecting indicating the computer PC#4 to switch outputting the signal of the keyboard 120 and the pointing device 110 to the computers PC#4 automatically without user's manual operation. If the result of the judgment step D9 is negative, the algorithm will proceed to judgment step D10 to determine if Ytotal>Y3, the algorithm will proceed to the step F6, which is setting n=2, Ysync=0 and calculating Xsync=(Xposition+Xoffset)*X2/X3 to obtain the adjacent position information on the second display 300b to move the active cursor seamlessly from the third display 300c to the adjacent position on the second display 300b. Meanwhile the processor 10 will generate the selecting indicating the computer PC#2 to switch outputting the signal of the keyboard 120 and the pointing device 110 to the computer PC#2 automatically without user's manual operation. If the result of the judgment step D10 is negative (N), the algorithm proceeds the step E to remain the selecting signal indicating the computer PC#3 to show the active cursor on the third display 300c.

In judgment step D4, if n=4, the algorithm will proceed to the judgment step D11 to determine if Xtotal>X4, the algorithm will proceed to the step F7, which is setting n=3, Xsync=0 and calculating Ysync=(Yposition+Yoffset)*Y4/Y3 to obtain the adjacent position information on the third display 300c to move the active cursor seamlessly from the fourth display 300d to the adjacent position on the third display 300c. Meanwhile the processor 10 will generate the selecting indicating the computer PC#3 to switch outputting the signal of the keyboard 120 and the pointing device 110 to the computers PC#3 automatically without user's manual operation. If the result of the judgment step D11 is negative, the algorithm will proceed to judgment step D12 to determine if Ytotal>Y4, the algorithm will proceed to the step F8, which is setting n=1, Ysync=0 and calculating Xsync=(Xposition+Xoffset)*X1/X4 to obtain the adjacent position information on the first display 300a to move the active cursor seamlessly from the fourth display 300d to the adjacent position on the first display 300a. Meanwhile the processor 10 will generate the selecting indicating the computer PC#1 to switch outputting the signal of the keyboard 120 and the pointing device 110 to the computer PC#1 automatically without user's manual operation. If the result of the judgment step D12 is negative (N), the algorithm proceeds the step E to remain the selecting signal indicating the computer PC#4 to show the active cursor on the fourth display 300d.

Consequentially, the active cursor of the pointing device 110 can be controlled by the user to move seamlessly from one display to another display. Furthermore, the cursor control system outputs signals of the pointing device 110 or the keyboard 120 to the computers automatically without a manual switch operation according to the cursor control method of the present invention.

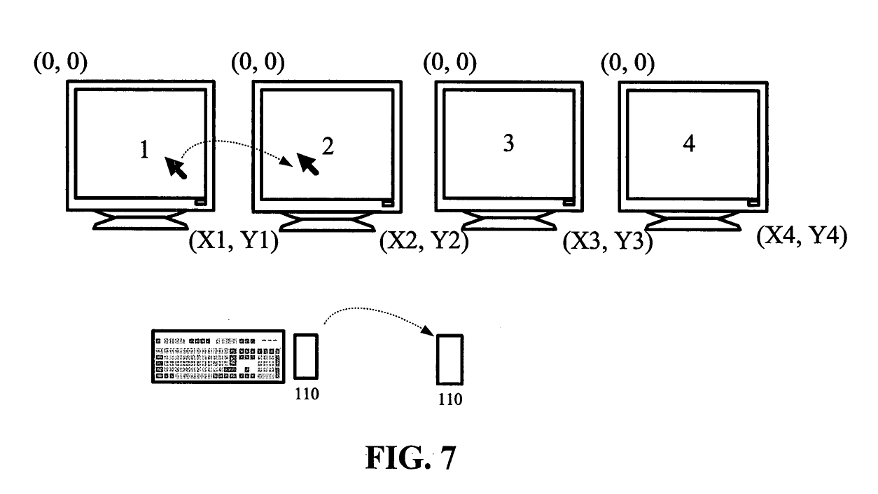

Please refer to FIG. 7. It shows a second arrangement of the physi-constructed displays according to the present invention. The arrangement of the displays can be in a line for minimizing the calculation of the algorithm. Meanwhile, such arrangement in a line is also for one better consideration about the user's intuition to recognize the relation about the first display 300a, second display 300b, third display 300c and fourth display 300d. In this second arrangement of the displays, four displays are illustrated but not a restriction to the present invention. Such as five, six or even more displays arranged in a line also can be considered. According to the second arrangement, the algorithm in the processor 10 shown in FIG. 3 and FIG. 4 will establish four coordinate axes (X1, Y1) for the first display 300a, (X2, Y2) for the second display 300b, (X3, Y3) for the third display 300c, and (X4, Y4) for the fourth display 300d. Each origin of each coordinate axis is set at the upper left corner of each display. The (Xn, Yn) at the lower right corner of each display denotes the resolution of the nth computer. The trajectory of the black cursor as shown in FIG. 5 denotes that the cursor can be moved from the first display 300a to the second display 300b adjacent to the first display 300a seamlessly corresponding to the movement of the pointing device 110.

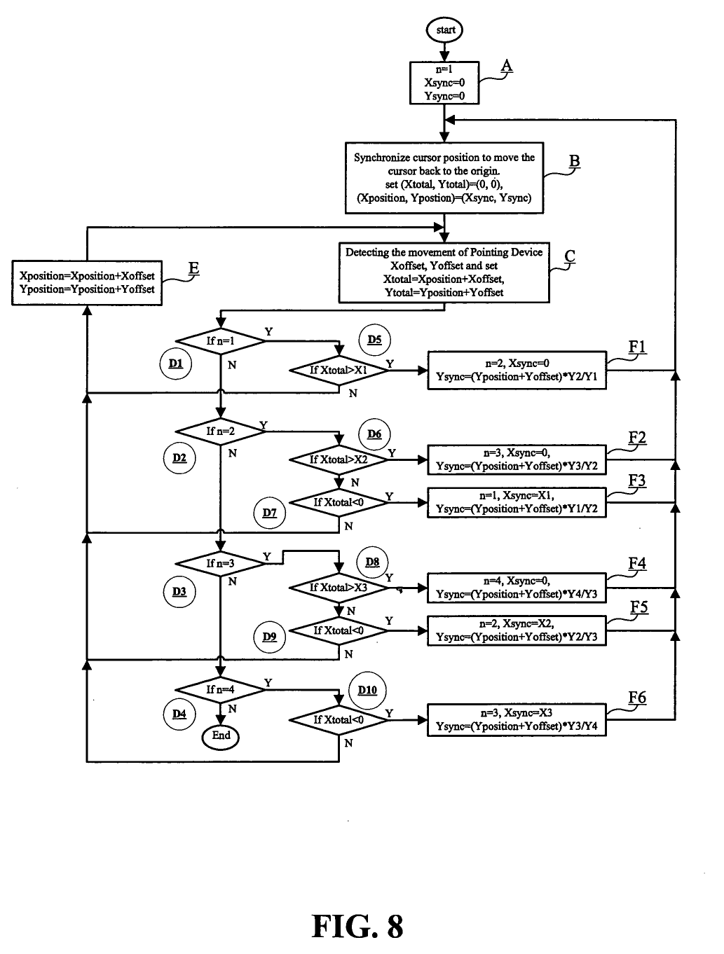

Please refer to FIG. 8, which shows a calculation flow chart of an algorithm, predetermined according to the second arrangement of the displays shown in FIG. 7 according to the present invention. First, as same as defined in first arrangement of the displays, Xsync and Ysync denote starting values of setting an active cursor position shown on the default display or the starting value calculated when the active cursor is moved from one display to another. In this first arrangement, in step A, setting the first display 300a (n=1) as the default display and the default setting is that Xsync=0 and Ysync=0, i.e. setting an active cursor controlled by the pointing device 110 starting on the first display 300a as default. In step B, the algorithm synchronizes the position of the active cursor to move the cursor back to the origin in the coordinate axis (X1, Y1). Therefore, it sets (Xtotal, Ytotal)=(0, 0) and (Xposition, Ypostion)=(Xsync, Ysync). The (Xtotal, Ytotal) denotes the total amount of the movement of the pointing device 110 in the coordinate axis (X, Y). (Xsync, Ysync) denotes the real position when the cursor is moved from one display to another display adjacent to the display. In step C, the processor 10 detects the movement (Xoffset, Yoffset) of pointing device 110. The algorithm inside the processor 10 calculates the movement result Xtotal=Xposition+Xoffset, Ytotal=Yposition+Yoffset, i.e. detecting the movement of the pointing device 110 to obtain the real-time position information of the active cursor on the first display 300a.

In step Dx, there will be ten judgment steps from D1 to D10. At D1 to D4 judgment steps, the algorithm will determine the real-time position of the active cursor on which of the displays. The processor 10 generates the selecting signal remains indicating the same computer. If the result in the judgment step (one of D1to D4) is positive (Y), the algorithm will proceed the next D5 to D10.

In judgment step D1, if n=1, the algorithm will proceed to the judgment step D5 to determine if Xtotal>X1, the algorithm will proceed to the step F1, which is setting n=2, Xsync=0 and calculating Ysync=(Yposition+Yoffset)*Y2/Y1 to obtain the adjacent position information on the second display 300b to move the active cursor seamlessly from the first display 300a to the adjacent position on the second display 300b. Meanwhile the processor 10 will generate the selecting indicating the computer PC#2 to switch outputting the signal of the keyboard 120 and the pointing device 110 to the computers PC#2 automatically without user's manual operation. If the result of the judgment step D5 is negative (N), the algorithm proceeds the step E to remain the selecting signal indicating the computer PC#1 to show the active cursor on the first display 300a.

In judgment step D2, if n=2, the algorithm will proceed to the judgment step D6 to determine if Xtotal>X2, the algorithm will proceed to the step F2, which is setting n=3, Xsync=0 and calculating Ysync=(Yposition+Yoffset)*Y3/Y2 to obtain the adjacent position information on the third display 300c to move the active cursor seamlessly from second display 300b to the adjacent position on the third display 300c. Meanwhile the processor 10 will generate the selecting indicating the computer PC#3 to switch outputting the signal of the keyboard 120 and the pointing device 110 to the computers PC#3 automatically without user's manual operation. If the result of the judgment step D6 is negative, the algorithm will proceed to judgment step D7 to determine if Xtotal<0, the algorithm will proceed to the step F3, which is setting n=1, Xsync=X1 and calculating Ysync=(Yposition+Yoffset)*Y1/Y2 to obtain the adjacent position information on the first display 300a to move the active cursor seamlessly from the second display 300b to the adjacent position on the first display 300a. Meanwhile the processor 10 will generate the selecting indicating the computer PC#1 to switch outputting the signal of the keyboard 120 and the pointing device 110 to the computer PC#1 automatically without user's manual operation. If the result of the judgment step D7 is negative (N), the algorithm preceeds the step E to remain the selecting signal indicating the computer PC#2 to show the active cursor on the second display 300b.

In judgment step D3, if n=3, the algorithm will proceed to the judgment step D8 to determine if Xtotal>X3, the algorithm will proceed to the step F4, which is setting n=4, Xsync=0 and calculating Ysync=(Yposition+Yoffset)*Y4/Y3 to obtain the adjacent position information on the fourth display 300d to move the active cursor seamlessly from the third display 300c to the adjacent position on the fourth display 300d. Meanwhile the processor 10 will generate the selecting indicating the computer PC#4 to switch outputting the signal of the keyboard 120 and the pointing device 110 to the computers PC#4 automatically without user's manual operation. If the result of the judgment step D8 is negative, the algorithm will proceed to judgment steps D9 to determine if Xtotal<0, the algorithm will proceed to the step F5, which is setting n=2, Xsync=X2 and calculating Ysync=(Yposition+Yoffset)*Y2/Y3 to obtain the adjacent position information on the display 2 to move the active cursor seamlessly from the third display 300c to the adjacent position on the second display 300b. Meanwhile the processor 10 will generate the selecting indicating the computer PC#2 to switch outputting the signal of the keyboard 120 and the pointing device 110 to the computers PC#2 automatically without user's manual operation. If the result of the judgment step D9 is negative (N), the algorithm proceeds the step E to remain the selecting signal indicating the computer PC#3 to show the active cursor on the third display 300c.

In judgment step D4, if n=4, the algorithm will proceed to the judgment step D10 to determine if Xtotal<0, the algorithm will proceed to the step F6, which is setting n=3, Xsync=X3 and calculating Ysync=(Yposition+Yoffset)*Y3/Y4 to obtain the adjacent position information on the third display 300c to move the active cursor seamlessly from the fourth display 300d to the adjacent position on the third display 300c. Meanwhile the processor 10 will generate the selecting indicating the computer PC#3 to switch outputting the signal of the keyboard 120 and the pointing device 110 to the computers PC#3 automatically without user's manual operation. If the result of the judgment step D10 is negative (N), the algorithm proceeds the step E to remain the selecting signal indicating the computer PC#4 to show the active cursor on the fourth display 300d.

According to the cursor control system and method thereof of the present invention, the user can control the active cursor of the pointing device 110 move from one display to another display adjacent to the display seamlessly. The user only needs the pointing device 110 or the keyboard 120 but being capable of controlling four computers, which are predetermined, selected from the plurality of computers. Furthermore, the cursor control system outputs the signals of the pointing device 110 and the keyboard 120 to the indicated computers according to the selecting signal automatically without a manual switch operation. As a result, the cursor control system and method thereof provides a control mode which is much more convenient to the user.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A cursor control system for displays of a plurality of computers, coupled to a keyboard or a pointing device, the displays and the computers for controlling the computers by the keyboard or the pointing device, the cursor control system comprising:
a plurality of resolution detectors, analyzing resolutions of video signals from the computers, respectively;
a processor, in response to the resolution detectors, calculating movement of the pointing device for obtaining a real-time position information of an active cursor on one of the displays to generate a selecting signal indicating one of the computers; and
a switch, switching to output signals of the keyboard or the pointing device to the indicated computer to show the active cursor on the corresponding display simultaneously according to the selecting signal to control the active cursor move from the display to another display adjacent to the display

2. The cursor control system of claim 1, wherein the active cursor is showed on the corresponding display coupled to the indicated computer according to the real-time position information.

3. The cursor control system of claim 1, further comprising a matrix switch, coupled to the computers and the resolution detectors for selecting the computers of equal number to the resolution detectors for transmitting the video signals from each of the selected computers to each of the displays, respectively.

4. The cursor control system of claim 1, further comprising a plurality of video line receivers coupled to the resolution detectors to equalize the video signals and provide a horizontal synchronization signal and a vertical synchronization signal for the resolution detectors.

5. The cursor control system of claim 1, wherein the processor calculates the movement of the pointing device based on an algorithm, which is predetermined according to an arrangement of the displays.

6. The cursor control system of claim 1, wherein the arrangement of the displays is in a line for minimizing the calculation of the algorithm.

7. The cursor control system of claim 1, wherein the arrangement of the displays is in a rectangularity for minimizing the calculation of the algorithm.

8. A keyboard-mouse-video switch system coupled to a keyboard or a pointing device, a plurality of displays and a plurality of computers for controlling the computers by the keyboard or the pointing device, the keyboard-mouse-video switch comprising:
a matrix switch, coupled to the computers to select the computers for transmitting the video signals from each of the selected computers to each of the displays, respectively;
a plurality of resolution detectors, analyzing the resolutions of the video signals from each of the selected computers, respectively;
a processor, calculating movement of the pointing device for obtaining a real-time position information of an active cursor on one of the displays to generate a selecting signal indicating one of the computers; and
a switch, switching to output signals of the keyboard or the pointing device to the indicated computer to show the active cursor on the corresponding display simultaneously according to the selecting signal to control the active cursor move from the display to another display adjacent to the display.

9. The keyboard-mouse-video switch system of claim 8, wherein the active cursor is showed on the corresponding display coupled to the indicated computer according to the real-time position information.

10. The keyboard-mouse-video switch system of claim 8, wherein the processor calculates the movement of the pointing device based on an algorithm, which is predetermined according to an arrangement of the displays.

11. The keyboard-mouse-video switch system of claim 8, wherein the arrangement of the displays is in a line for minimizing the calculation of the algorithm.

12. The keyboard-mouse-video switch system of claim 8, wherein the arrangement of the displays is in a rectangularity for minimizing the calculation of the algorithm.

13. The keyboard-mouse-video switch system of claim 8, further comprising a plurality of input/output modules, coupled to the respective computers and the keyboard-mouse-video switch to transform the video signals from an analog format into a differential format for the resolution detectors to analyze the resolutions.

14. The keyboard-mouse-video switch system of claim 8, further comprising a plurality of console modules, coupled to the keyboard-mouse-video switch and the respective displays to transform the video signals of the keyboard-mouse-video switch from the differential format into the analog format for the respective displays.

15. The keyboard-mouse-video switch system of claim 14, wherein the signals of the keyboard or the pointing device coupled to one of the console modules is broadcasted to another computer by the keyboard-mouse-video switch for transmitting the signals of the keyboard or the pointing device to another console module through the switch according to the selecting signal indicating the another computer for showing the active cursor on the corresponding display coupled to the another console module.

16. The keyboard-mouse-video switch system of claim 8, further comprising a plurality of video line receivers coupled to the resolution detectors to equalize the video signals and provide a horizontal synchronization signal and a vertical synchronization signal for the resolution detectors.

17. A cursor control system coupled to a keyboard or a pointing device, a plurality of displays and a plurality of computers for controlling the computers by the keyboard or the pointing device, the keyboard-mouse-video switch comprising:
a matrix keyboard-mouse-video switch, coupled to the computers to select the computers for transmitting the video signals from each of the selected computers respectively;
a plurality of console modules, transmitting the video signals from the matrix keyboard-mouse-video switch to each of the displays, respectively and transmitting the keyboard signals and the pointing device signals to the computers through the matrix keyboard-mouse-video switch;
a processor, calculating movement of the pointing device for obtaining a real-time position information of an active cursor on one of the displays to generate a selecting signal indicating one of the computers; and
a keyboard-mouse-video switch, switching to output signals of the keyboard or the pointing device to the indicated computer through the corresponding console module and the matrix the keyboard-mouse-video switch to show the active cursor on the corresponding display simultaneously according to the selecting signal to control the active cursor move from the display to another display adjacent to the display.

18. The cursor control system of claim 17, wherein the active cursor is showed on the corresponding display coupled to the indicated computer according to the real-time position information.

19. The cursor control system of claim 17, wherein the processor calculates the movement of the pointing device based on an algorithm, which is predetermined according to an arrangement of the displays.

20. The cursor control system of claim 17, wherein the arrangement of the displays is in a line for minimizing the calculation of the algorithm.

21. The cursor control system of claim 17, wherein the arrangement of the displays is in a rectangularity for minimizing the calculation of the algorithm.

22. The cursor control system of claim 17, further comprising a plurality of input/output modules, coupled to the respective computers and the matrix keyboard-mouse-video switch to transform the video signals from an analog format into a differential format.

23. The cursor control system of claim 17, wherein the console modules transform the video signals received from the matrix keyboard-mouse-video switch from the differential format into the analog format for the respective displays.

24. A cursor control method for controlling a plurality of computers by the keyboard or the pointing device, the cursor control method comprising the steps of:
calculating movement of the pointing device by an algorithm to obtain a real-time position information of an active cursor on one of a plurality of displays;
generating a selecting signal indicating one of the computers according to the real-time position information;
switching to output signals of the keyboard or the pointing device to the indicated computer to show the active cursor on the corresponding display simultaneously according to the selecting signal; and
controlling the active cursor move from the display to another display adjacent to the display.

25. The cursor control method of claim 24, wherein the algorithm further comprising the steps of:
setting an active cursor controlled by the pointing device starting on one of the displays as default;
synchronizing the position of the active cursor to move the active cursor back to the original position on the default display;
detecting the movement of the pointing device to obtain the real-time position information of the active cursor;
determining the real-time position of the active cursor on which of the displays to generate the selecting signal indicating one of the computers; and
calculating an adjacent corresponding position of the adjacent display which the active cursor is moved to, to control the active cursor move from the display to the adjacent corresponding position of the adjacent display according to the selecting signal.

26. The cursor control method of claim 24, further comprising a step of predetermining the algorithm of calculating movement of the pointing device according to an arrangement of the displays before the step of calculating movement of the pointing device.

27. The cursor control method of claim 24, further comprising a step of selecting the computers of equal number to the displays for transmitting the video signals from each of the selected computers to each of the displays, respectively.

28. The cursor control method of claim 24, further comprising a step of analyzing resolutions of video signals from the computers corresponding to the displays, respectively, for the algorithm before the step of calculating movement of the pointing device.

29. A cursor control method for controlling an active cursor on a plurality of displays, the method comprising the steps of:
setting the active cursor starting on one of the displays as default;
synchronizing the position of the active cursor to move the active cursor back to the original position on the default display;
detecting the movement of the pointing device to obtain the real-time position information of the active cursor;
determining the real-time position of the active cursor on which of the displays to generate a selecting signal indicating one of the computers; and
calculating an adjacent corresponding position of the adjacent display, which the active cursor is moved to, to control the active cursor move from the display to the adjacent corresponding position of the adjacent display according to the selecting signal.
